(19) United States
(12) Patent Application Publication
(10) Pub. No.: US 2005/0086129 A1
(43) Pub. Date: Apr. 21, 2005

(54) Cross-branding reservation and tracking system

(76) Inventors: Pasquale A Patullo, Hollywood, FL (US); Thomas L. Trotta, Cooper City, FL (US)

Correspondence Address: KATTEN MUCHIN ZAVIS ROSENMAN, 525 WEST MONROE STREET, CHICAGO, IL, 60661-3693, US

(21) Appl. No.: 10/490,428

(22) PCT Filed: Sep. 24, 2002
(86) PCT No.: PCT/US02/30229

Related U.S. Application Data
(60) Provisional application No. 60/324,318, filed on Sep. 24, 2001.

(51) Int. Cl. G06F 17/60

(52) U.S. Cl. 705/27

(57) ABSTRACT

A cross-branding reservation and tracking system for disseminating travel information, making and booking travel arrangements, and tracking use thereof. Websites of travel agencies or non-travel related business affiliates are linked to a customized reservation and booking site at which information on various resorts and travel arrangements is presented in a cross-branded format. Reservations are booked through a centralized booking engine component of the customized site. Tracking functions audit and report on click-through activity originating from each affiliated site. Multiple affiliations through a single affiliated URL are also enabled.

### RELATED APPLICATIONS

This application is a continuation-in-part of U.S. application Ser. No. 09/828,437, filed Apr. 6, 2001, entitled “Reservation System”.

### FIELD OF INVENTION

The present invention generally relates to a computer network for linking separate computer programs to give users of the first system, complete access to the second system while displaying and using key attributes of the first system throughout the second system. This system links a supplier system with its wholesaler, retailer, distribution and advertising partners. The network centers around the distribution of information and co-branding that information. The ultimate purpose is to conduct electronic commerce. The initial application is used for distributing travel information, arranging travel reservations, and more particularly to a computerized booking engine. Complete tracking of on-line web-linked activity is also provided.

### BACKGROUND OF THE INVENTION

With the widespread use of public computer networks such as the Internet, there is a need to provide consumers, travel advertisers, travel distribution partners, travel agents, and travel wholesalers, with more convenient, efficient and useful computer systems for making a wide range of travel arrangements via the computer network. Such networks must also collect marketing data for the benefit of multiple parties and also track the usage of the network to provide partnering entities with data and reports on the networks performance. It is also increasingly a benefit to also co-operatively advertise and brand linked systems.

Prior art computer systems have many drawbacks, including lack of truly integrated systems and failure to pass information between systems. For example, prior art computer systems have only framed vendor information on pages of an affiliate's web site. Meaning that in vendor to affiliate transactions, information relating to the vendor's products and services is carried over onto the affiliate page. Therefore, as you continue through various affiliate's pages, the original vendor and their reference information is always displayed. However, there was never any reciprocation of information framed on affiliate web sites. Thus, in affiliate to vendor transactions, affiliate information was not carried over onto the vendor page.

Additionally, prior art computer systems also lack many reporting features, such as data collection for each linked entity, network usage tracking, access to the data collected and ability to make direct or third party transactions capturing information for all entities involved in the transaction.

The present invention addresses these and other drawbacks of prior art computer systems for linking travel partners, displaying co-branded information, and making travel arrangements.

### SUMMARY OF THE INVENTION

According to the present invention there is provided a linking and integrating program for separately controlled web sites that leads to a booking engine for making travel arrangements. This program is used for distributing travel information and arranging travel reservations through a central website which is linked and cross-branded with other web sites.

The present invention provides web site visitors with vendor and affiliate information. The invention is a truly integrated system such that vendor information is displayed on pages of the affiliate's web site and affiliate information is displayed on pages of the vendor's web site. A vendor would provide the affiliate with a unique link for placement on the affiliate's web site, which would correspond to a page on the vendor's web site. The link would generate a cookie which contains information about the affiliate. This affiliate information is then displayed on the vendor's web site and vendor information displayed on the affiliate's web site.

An advantage of the present invention is the provision of an imbedding agent that provides improvements in ease of operation, flexibility, transportation, speed, storage and functionality.

Another advantage of the present invention is the provision of an imbedding agent that provides new and unique features for improved conveniences.

Still other advantages of the invention will become apparent to those skilled in the art upon a reading and understanding of the following detailed description, accompanying drawings and appended claims.

### BRIEF DESCRIPTION OF THE DRAWINGS

The invention may take physical form in certain parts and arrangements of parts, a preferred embodiment and method of which will be described in detail in this specification and illustrated in the accompanying drawings which form a part hereof, and wherein:

FIG. 1A is a general flow diagram illustrating operation of a web-link according to a preferred embodiment of the present invention;

FIG. 1B is a general flow diagram illustrating how an agent or affiliate would enroll in the web-link network;

FIG. 1C is a general flow diagram illustrating how an agent or affiliate would access the reporting system;

FIG. 2A illustrates an exemplary co-branded web-link home page for travel agencies, according to a preferred embodiment of the present invention;

FIG. 2B illustrates an exemplary co-branded web-link home page for non-travel affiliates, according to a preferred embodiment of the present invention;

FIG. 3A illustrates an exemplary web-link rates and reservation inquiry display for travel agencies, with intermediary information displayed according to a preferred embodiment of the present invention;

FIG. 3B illustrates an exemplary web-link rates and reservation inquiry display for non-travel affiliates, with intermediary information displayed according to a preferred embodiment of the present invention;

FIG. 4A illustrates an exemplary web-link reservation system display for travel agencies according to a preferred embodiment of the present invention;

FIG. 4B illustrates an exemplary web-link reservation system display for non-travel affiliates according to a preferred embodiment of the present invention;

FIG. 5 illustrates an exemplary travel agent finder page displaying participating and non-participating web-link agencies, according to a preferred embodiment of the present invention;

FIG. 6 illustrates an exemplary web-link reporting menu log-in page, according to a preferred embodiment of the present invention;

FIG. 7 illustrates an exemplary web-link reporting menu page, according to a preferred embodiment of the present invention;

FIG. 8 illustrates an exemplary web-link reporting statistics page, according to a preferred embodiment of the present invention;

FIG. 9 illustrates an exemplary web-link reporting reservations history page, according to a preferred embodiment of the present invention;

FIG. 10 illustrates an exemplary reporting reservations detail page, according to a preferred embodiment of the present invention;

FIGS. 11A and B illustrates an exemplary web-link sign-up page, according to a preferred embodiment of the present invention.

### DETAILED DESCRIPTION OF THE PREFERRED EMBODIMENT

It should be understood that while a preferred embodiment of the present invention is described herein in connection with linking travel agencies, wholesalers, and advertising affiliates to display hotel facilities and activities and for making travel arrangements for a resort, airline flights, and trip insurance, the present invention is not intended to be limited to the same. In this regard, it is contemplated that the present invention is suitably used in connection with other types of travel arrangements, including but not limited to hotels/motels, condominium and vacation home rentals, cruise ships, train travel, car rentals, excursions, tours, and other forms of accommodations and transportation. Additionally, this system can be used in many industries with manufacturers/suppliers, inform, distribute, and sell their products through wholesaler, retailer, and advertising organizations.

In the following detailed description of the present invention, reference is made to the accompanying drawings which, in conjunction with this detailed description, illustrate and describe a system which facilitates information dissemination, transactions, and branding benefits; directly to the linking party (linkee) and also to third parties (consumers) attracted either by the supplier (linkor) or the linked party. More specifically, the present invention allows for reciprocation of information framed on vendor's and affiliate's web sites. Usually, only information relating to the vendor's products and services is carried over onto pages of the affiliate's web site. However, in the present invention there is reciprocation between the information framed. Here, vendor information is carried over to the affiliate's web site, and affiliate information is carried over to the vendor's web site.

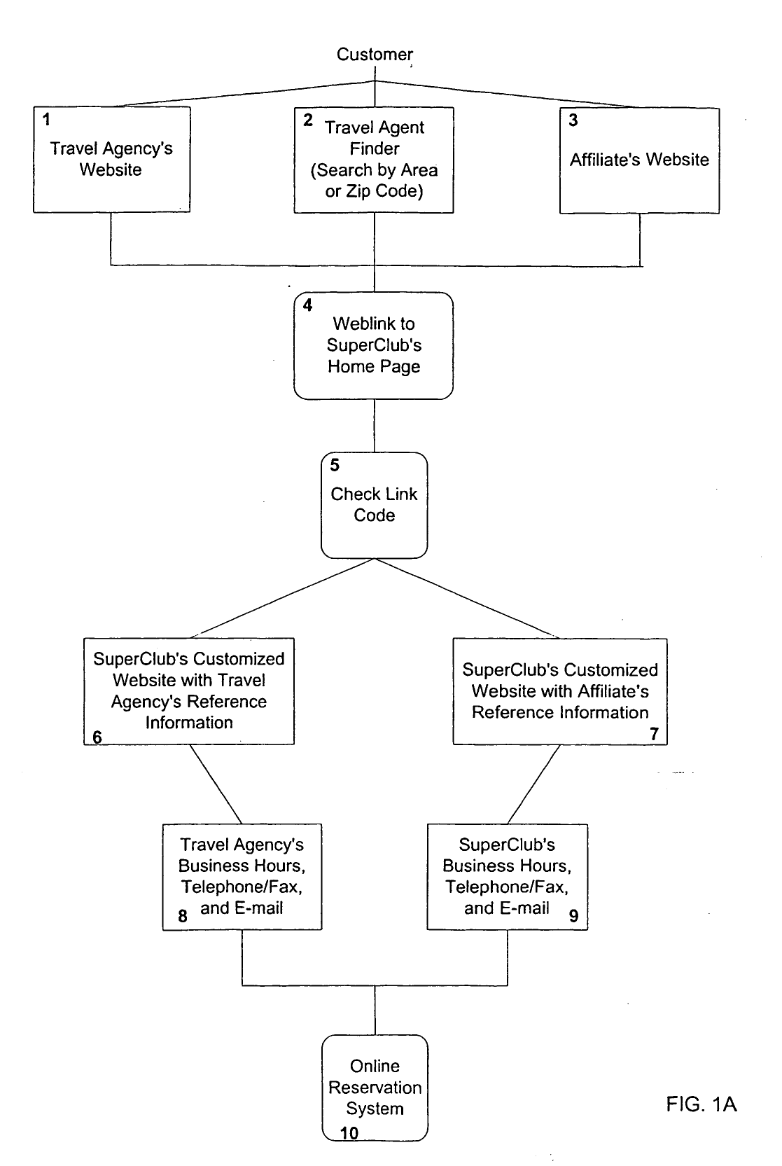

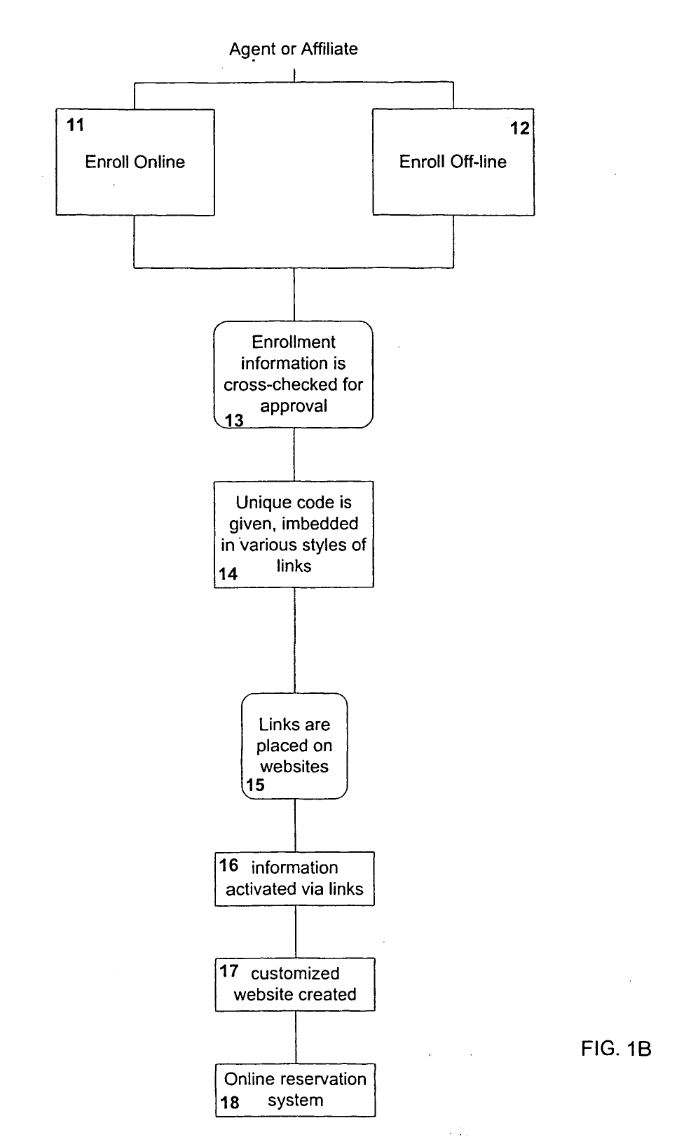

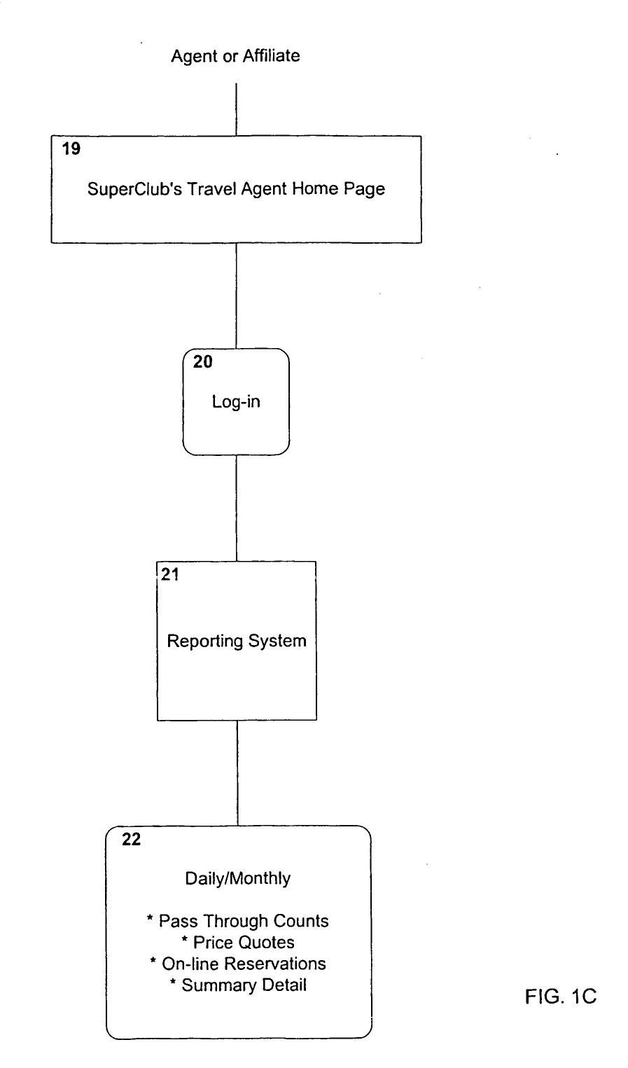

FIG. 1A illustrates the operation of a travel accommodation, description, price/rate quotation, and booking engine web site of the present invention. The flow diagram specifically outlines the various ways a customer can access the computer network.

First, a customer can access the network through a specific travel agency's web site, block 1, such as for example “ABC Travel”. Once at ABC Travel's web site, block 1, the customer would then click on a banner or icon on that site (such as a page footer) which is a link to a master reservation and tracking site and network, such as the “SuperClubs” affiliate program. The customer is then web-linked to a SuperClubs Home Page, block 4. The system checks the web-link code and verifies that ABC Travel is enrolled in the network at block 5. Once this is verified, the customer is then linked to a SuperClubs customized web site, co-branded with ABC Travel's information in the main body of each page and ABC Travel's phone number in the footer of each page, block 6. Next, the customer would then click on the on-line reservation icon. This transfers the customer to a site displaying ABC Travel's business hours, telephone/fax, and email address, block 8. This site also displays an icon for price quotes and reservations. Once the customer clicks on the price quotes and reservations icon, they are transferred to an on-line booking engine, block 10. Exemplary operation of an appropriate online booking engine is described in applicant's related patent application entitled, “Reservation System”. The customer then completes the required information and electronically submits the reservation. ABC Travel would then receive full commission for the reservation, because the transaction was initiated from the ABC website.

A customer could alternatively access the integrated cross-branded website network by going directly to the SuperClubs Home Page, block 4, and searching for a participating travel agency by area code or zip code, block 2. Once a specific travel agency is found, such as ABC Travel, a customer clicks on the corresponding icon and is then web-linked to the SuperClubs Home Page, block 4. The system checks the web-link code and verifies that ABC Travel is enrolled in the network at block 5. Once this is verified, the customer is then linked to the SuperClubs customized web site, co-branded with ABC Travel's information in the main body of each page and ABC Travel's phone number in the footer of each page, block 6. Next, the customer would then click on an on-line reservation icon on a page at this site. This transfers the customer to a site displaying ABC Travel's business hours, telephone/fax, and email address at block 8. The site also displays an icon for price quotes and reservations. Once the customer clicks on the price quotes and reservations icon, they are transferred to the on-line booking engine/reservation system at block 10. The customer then completes the required information and electronically submits the reservation. ABC Travel would in this case also receive a commission for the reservation having been originated from the ABC website.

Another way a customer can access the network is through a website of an affiliate, which may be for example a business other than a travel agency. The process is basically the same as with a network-enrolled travel agency. The customer goes to an affiliate web site, block 3, such as XYZ Swimwear. Once at XYZ Swimwear's web site, block 3, the customer would click on the Superclubs' Icon in the footer of an introductory page. The customer is then web-linked to the SuperClubs Home Page, block 4. The system checks the web-link code and verifies that XYZ Swimwear is enrolled in the network at block 5. Once this is verified, the customer is then linked to the SuperClubs customized web site, which is co-branded with XYZ Swimwear's information in the main body of each page and XYZ Swimwear's phone number in the footer of each page, block 7. Next, the customer would then click on the on-line reservation icon. This transfers the customer to a site displaying Superclub's business hours, telephone/fax, and email address, block 9. The site also displays an icon for price quotes and reservations. Once the customer clicks on the price quotes and reservations icon, they are transferred to the on-line booking engine/reservation system, block 10. The customer then completes the required information and electronically submits the reservation. Superclub's information is displayed instead of the affiliate's information in the case where the affiliate (being in a non-travel related business) cannot fulfill travel reservations. However, the affiliate would still get some sort of compensation or commission for the transactions originating from its website.

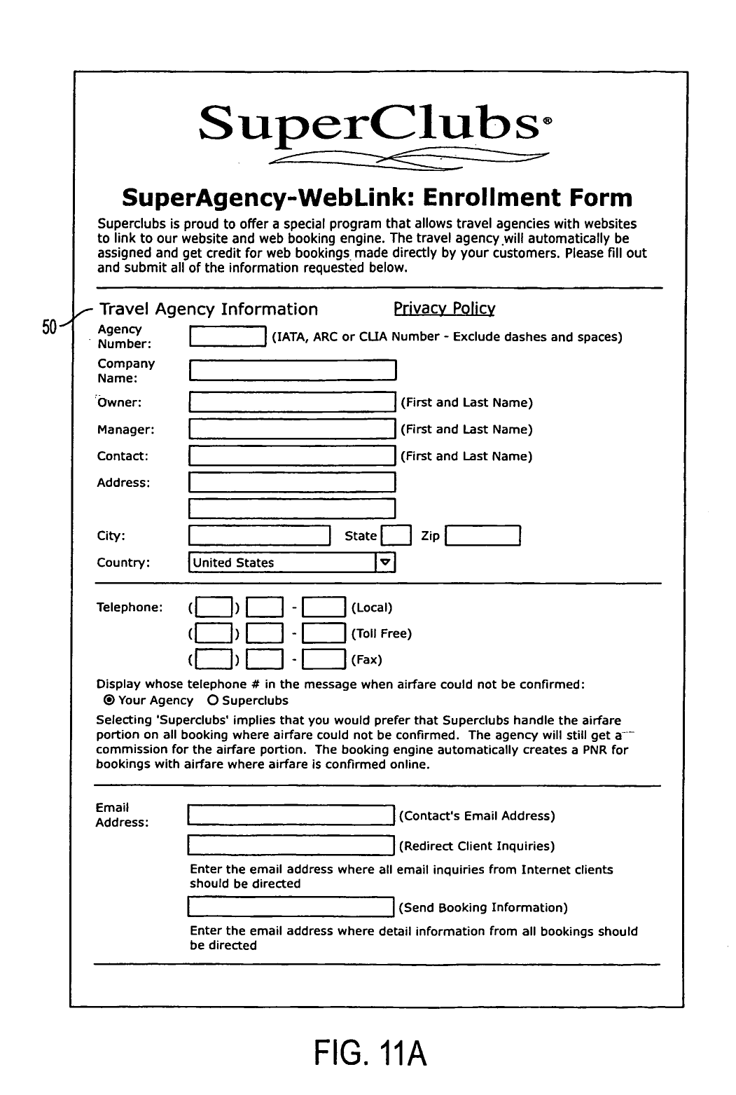

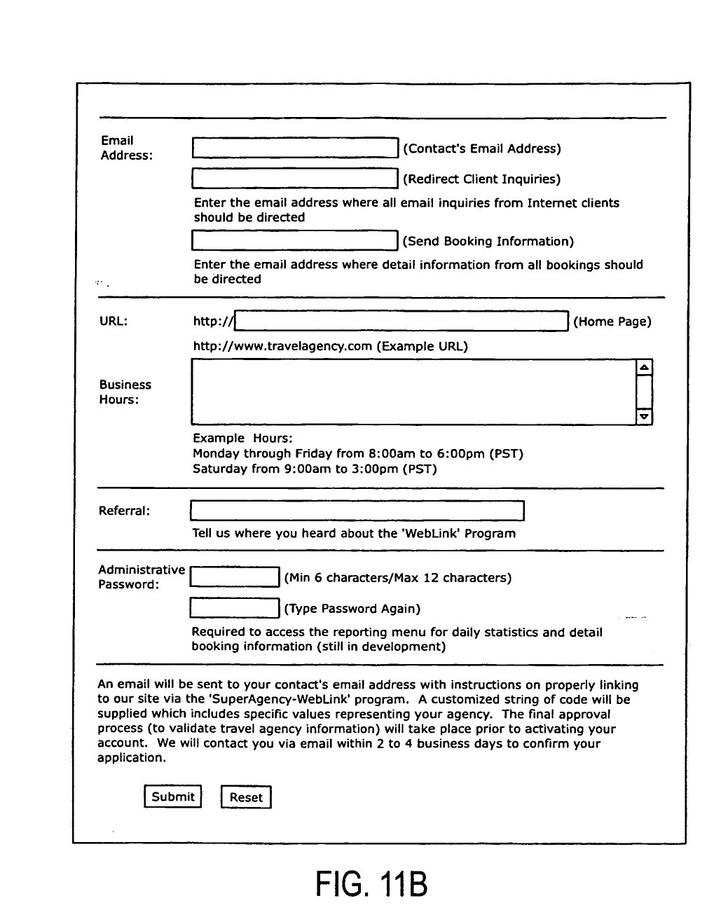

FIG. 1B illustrates how an agent or affiliate would become a part of the network. A wholesaler, retailer or affiliate signs up for the program either directly on-line through a sign-up form page, block 11 or with an off-line form, block 12. One example of an on-line enrollment form is shown in FIGS. 11A and 11B. Travel agency or affiliate information, such as name, address, telephone number, email address, etc. is identified in field 50. The sign-up process consists of providing contact information, all the information to be displayed on the program's web pages when the program is in use, the website to link third party users back to via a hot-link, and for wholesalers and retailers, their industry identification number. All of this information is cross-checked and synched with any other information in various databases at block 13. These linkees are each given a unique code at block 14 for identification purposes within the web-link program. Each linkee can have multiple unique codes grouped for various tracking and reporting purposes.

Once the sign-up of a linkee is approved, the linkee is sent their unique code, imbedded in various styles of links at block 14. They are also given instructions on how to place those links on their web sites at block 15. Minor variations to the links can route visitors to different entry points (pages) to the linkor's website(s). A listing of these variations is given to the linkees. Each different link can be tracked and reported separately and in total for each unique code.

Once a visitor to the linkee's website, or even e-mail with the special link imbedded in it, clicks on the link, a new window opens and the linkor's website is called up. The unique code imbedded in the link generates a cookie that activates information supplied by the linkee in the sign-up process and stored in the linkor's databases at block 16. This information is displayed either in addition to or in place of the linkor's information on each web page, depending on how the special code was programmed on each page at block 17.

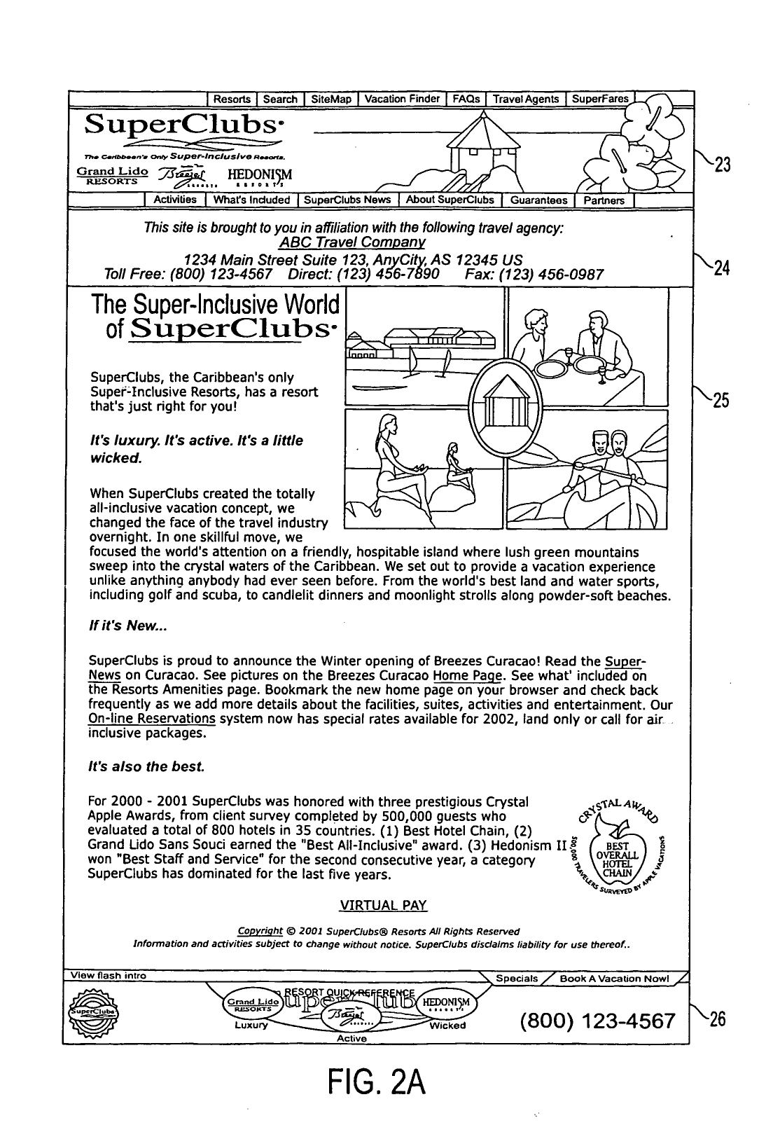

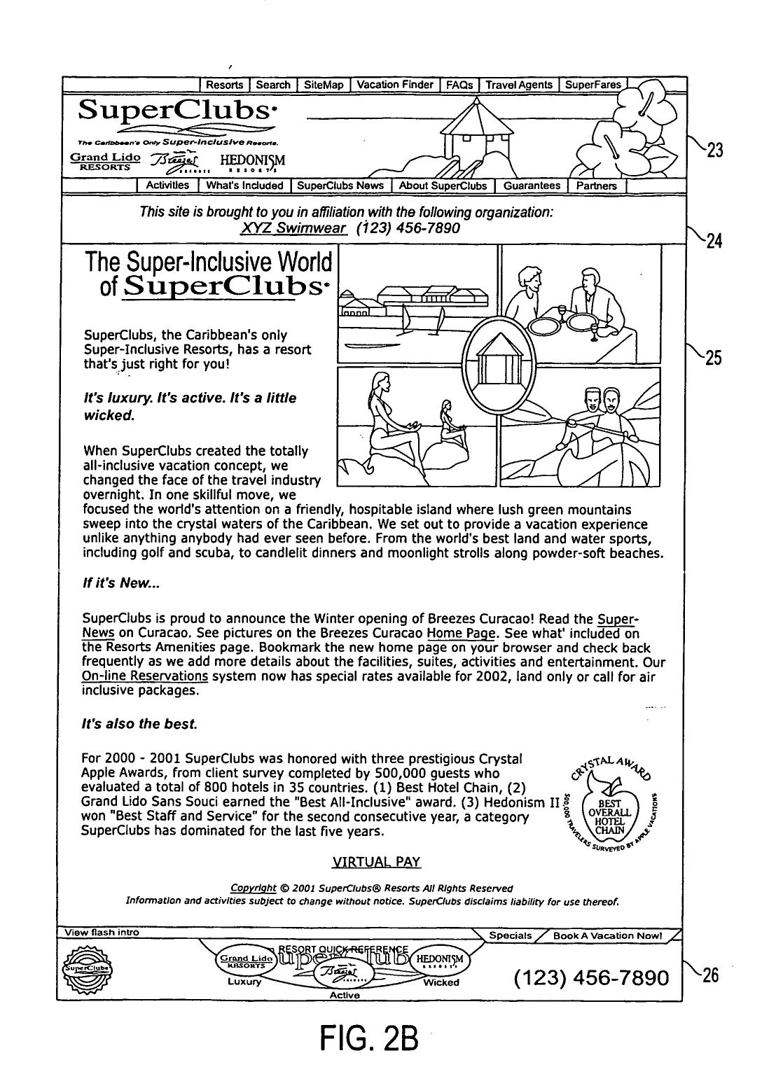

Once an agency or affiliate is enrolled in the network, direct links to the home page of the corporation, each of its brands, and each of its hotels will add an introductory section to the top center body of every home page, while still retaining the SuperClub's reference, block 17. For example, as shown in FIGS. 2A and 2B, a web-link visitor is greeted by “This web site is brought to you by” followed by the descriptive name of the linkee (i.e. travel agency or marketing affiliate) in field 24. The very top of the page contains the SuperClub's banner in field 23. In some cases, a linkee will combine their name with a consortium they belong to, in some cases the agency will also attach the name of a marketing partner such as a credit card company or affinity group or independent contractors for branding and tracking purposes. In at least once instance, no greeting or branding was used but the cookie was still used for tracking purposes. Thus the web-link was transparent to the visitor. The original reason for this transparency, was that the linkee, a marketing affiliate, was bringing visitors to the linkor's web site from multiple origins and it would have been confusing to the visitors to either see the branding of a competing marketing channel or see the branding of a generic marketing term or channel.

Additionally, on the bottom right hand side of every page on the linkor's web sites, the program replaces the existing phone number with the linkee's name and a new phone number in field 26. The linkee has the option to choose (during sign-up) if they want their phone number to be shown or the linkor's phone number. The linkor can also choose to use a unique phone number that can be tracked separately and also answered with a specific greeting.

Whenever a name of the linkee does appear on a home page or on the bottom right hand corner of the pages' footer, it also serves as a hot link back to the linkee's designated web site. If a visitor clicks on the name, the web-link window closes and the visitor is sent back to the linkee's web site.

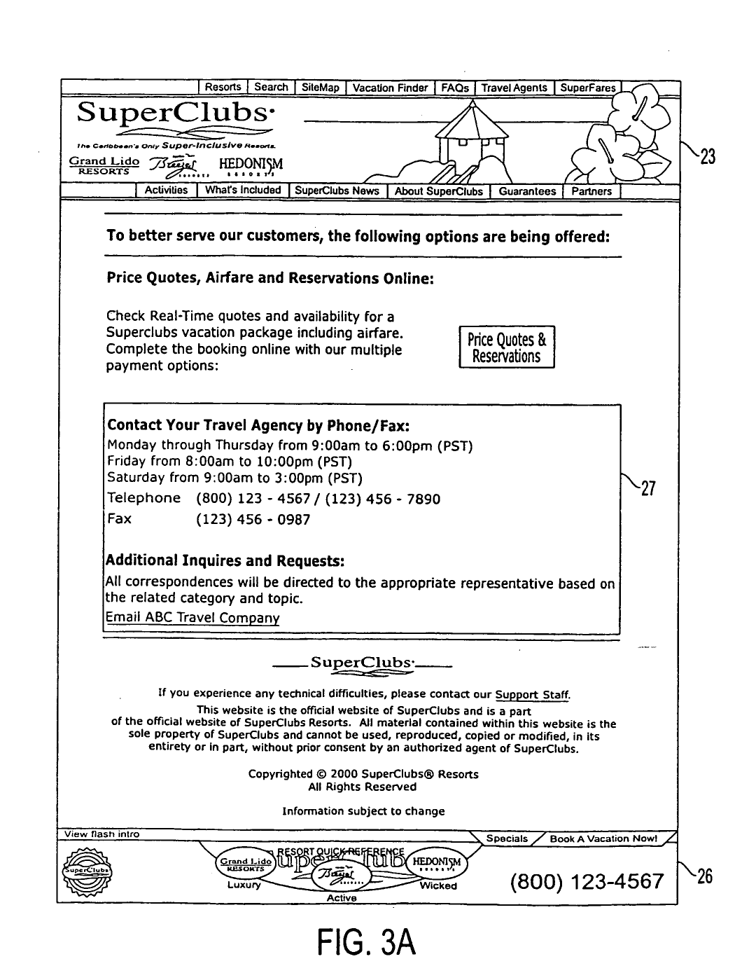

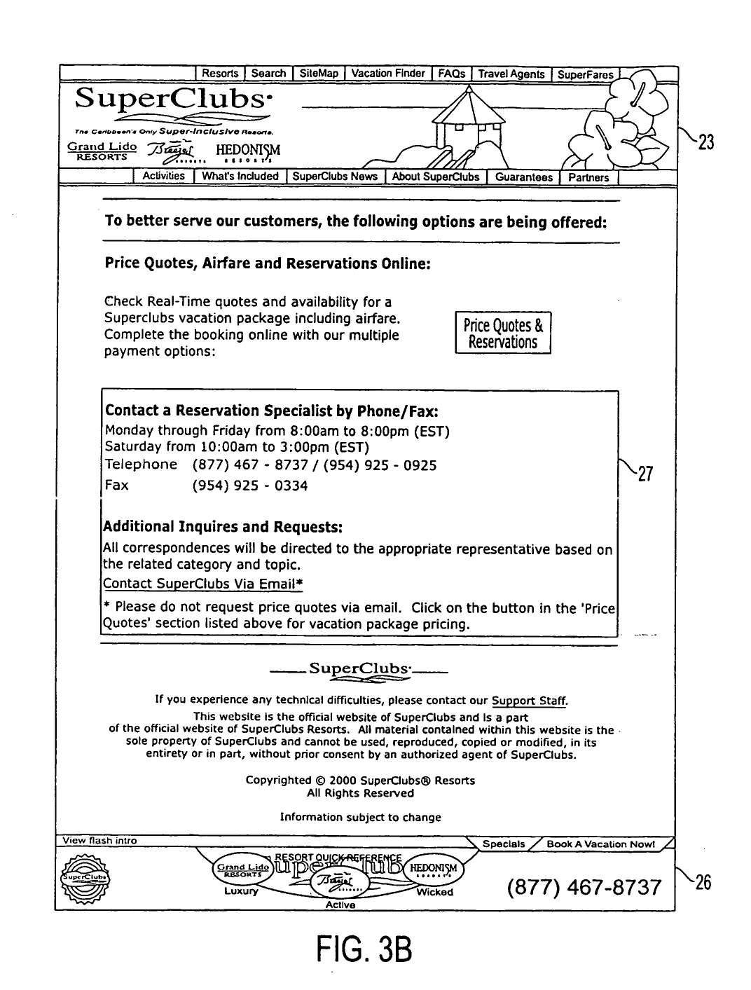

Visitors can also access additional information from the linkee. For example, as shown in FIGS. 3A and 3B, a linkee's address, phone number, fax number, web address, or e-mail address, etc. . . . can be listed in this same area (top center of the body) of every home page on the linkor's web sites, for example in field 27. Additional inquiries and requests can then be emailed to the linkee, if the linkee is a travel agency, such as ABC Travel or to the linkor, SuperClubs, if the linkee is an affiliate. When the linkee is a travel agency, their email address is displayed in place of SuperClubs.

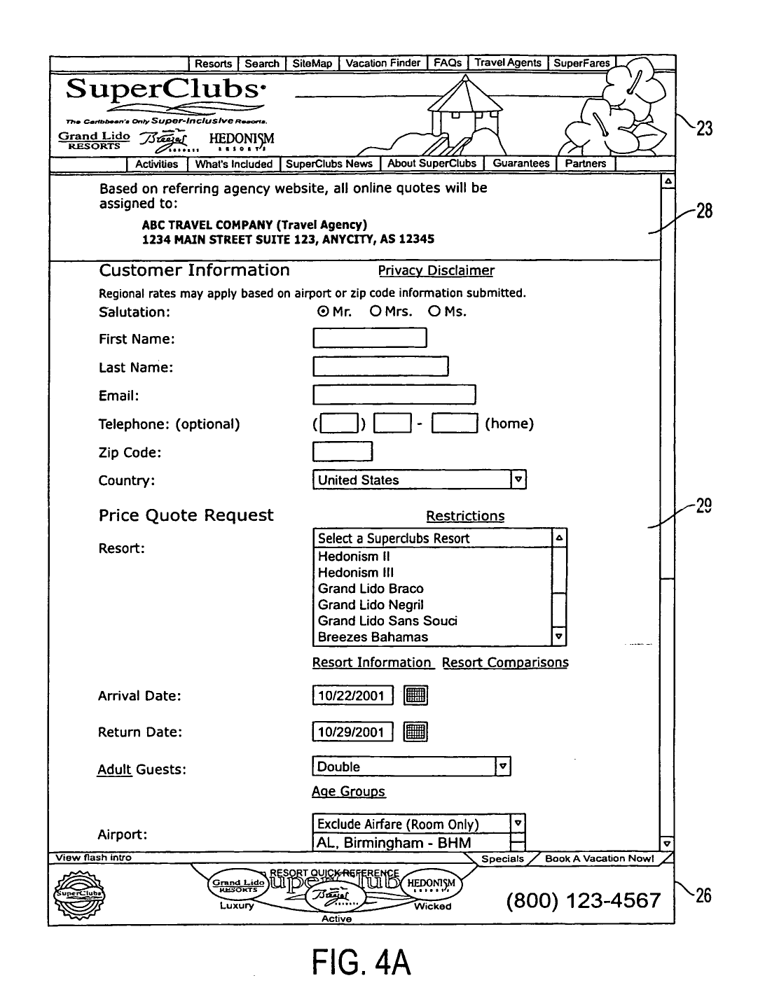

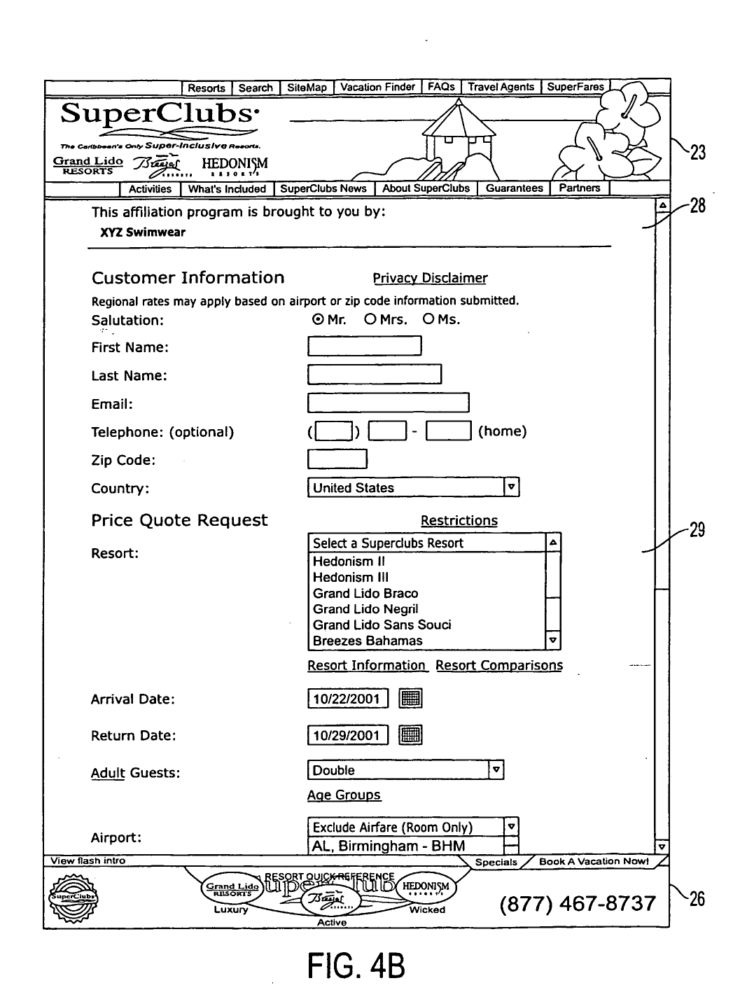

In the current application, visitors to the linkors site(s) are then seamlessly passed (or web-linked directly) to another site of the linkor for related e-commerce activity. This current e-commerce site is a travel booking engine or online reservation system, represented at block 18 in FIG. 1B, as described in the related patent application. The web-link coding on this site's footer works the same way for the name and phone number as described above. The first page a web-link visitor will come to in this path, is a reservation booking request page, as shown for example in FIGS. 4A and 4B. The web-link cookie of a travel partner will prompt a note at the top center of the body of this request page that makes it clear from the start that “all reservations made herein will be services by (the name of the linkee) in field 28. A visitor can then proceed to fill in their customer information and request a price quote or make a reservation in field 29.

If the visitor proceeds to obtain price quotes and make a reservation, all of these actions are tracked. The reservation will be credited to the travel company and the travel company will be rewarded just as if they had made the reservation for the visitor.

When obtaining a price quote, the visitor (at the option of the linkor) may be required to fill in personal information about themselves. The web-link cookie instructs the program to save this information in a segregated database created just for the visitors of the specific linkee that they originated from. These segregated databases are subject to a privacy policy set up by the linkor.

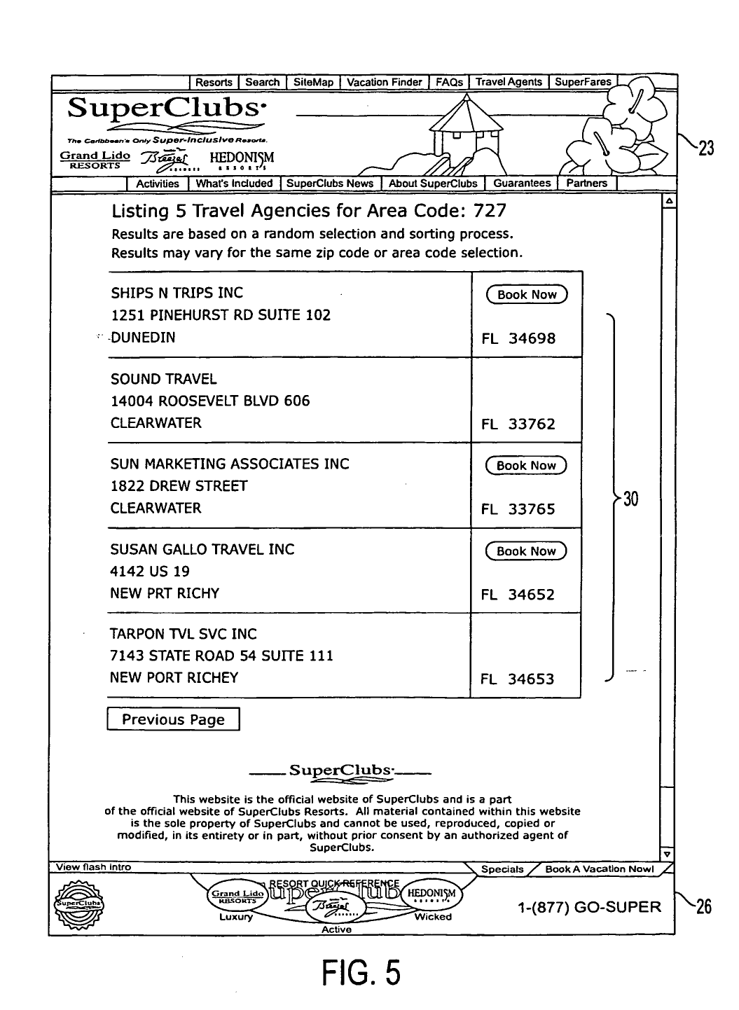

FIG. 5 illustrates how visitors to this booking engine are also given the option to search for travel agencies by area code or zip code, as presented in field 30. Additionally, when the linkor attracts visitors to its own web site directly, the visitor may find the travel agent finder program. This finder program does not have to be just for travel agents and the information listed therein, does not have to be limited just to their street address. The linkor can establish its own criteria for inclusion in this combined (web-link and finder) system. In the current system a linkee that has met the criteria will have an additional identification next to its contact (currently their street address) information. Currently that identification also serves as a link. Once a linkor's visitor clicks the link, the linkor's web site(s) are automatically transformed into the web-link mode for the linkee (listed in the finder). While the initial version of the web-link program relied on linkees to pull visitors to the linkor's site, this additional system acts to push the linkor's visitors to the linkee. This reciprocation has many benefits for linkor and linkee that do not need to be listed herein. The cookie used in this push version of the program, does not allow the linkee's name once triggered on the web pages, to act as a hot link back to the linkee's web site unless the linkee's site does not feature any other supplier other than the linkee. While different criteria can be used to allow the hot link or not, this additional feature of the program is unique to this web-link system.

However, when web-link visitors originate from a travel agency, the cookie changes the booking engine to completely eliminate this travel agent search option from the web page. Note: this elimination also occurs on the home page of the travel agent section of the linkor's web site. Within the linkor's booking engine site, visitors are usually able to identify themselves as a travel agent (and enter their travel identification number for tracking, reporting, and commission purposes) or a direct guest (consumer). The web-link cookie changes this display, only giving the visitor access as a direct consumer. However, the identification number of the linkee is automatically imbedded in the e-commerce web pages that and booking system once a web-link visitor chooses to follow this e-commerce path.

The linkor can also offer to link this combined finder and weblink program to third parties such as consortiums of linkees. On the central consortium site of linkees, a link to the linkor's combined program can be created. This will allow visitors to the consortium to select specific consortium members (linkees) and then link to the supplier (linkor's) site for the benefit of all parties. All tracking, reporting, and reward features of the program are included in this version of the program. In this version, the finder is limited only to members of the consortium. The linkor would work with the consortium for mass sign-ups of all consortium members that had not become linkees on their own. This enables, for example, a travel agent which has related satellite agents, to use the same website URL for each satellite agent, even though each satellite agent may have a unique industry identifier, such as an IATA number.

In the future other e-commerce sites with shopping carts will be linked and interact with the web-link cookie and travel industry identification number in the same manner as the booking engine. The linkor has also set up its own internal identification numbering system and can track, report, and reward affiliates for e-commerce transactions their visitors conducted.

The cookie currently used in the web-link program is set to expire once the visitor's current browser session is terminated. This could be changed by the linkor and set for longer period of time (days, weeks, etc. . . . ) that would last well beyond the current browser session.

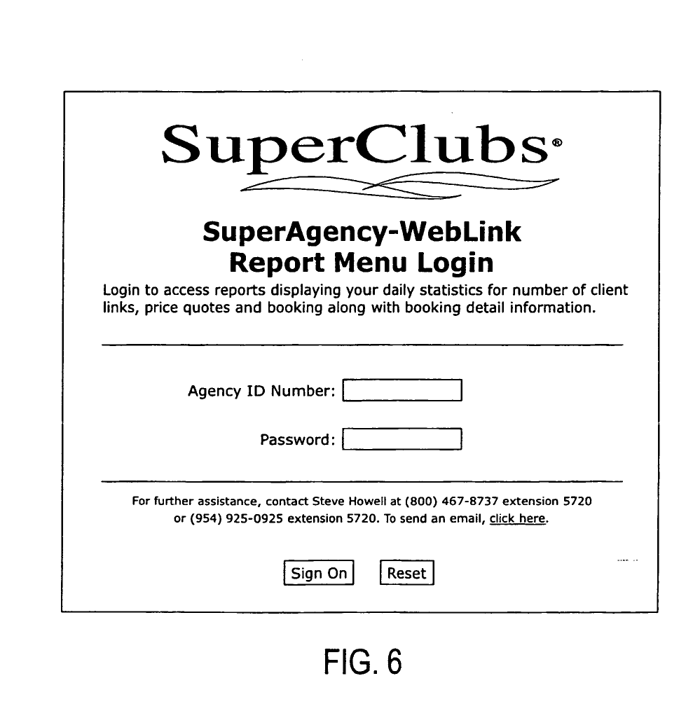

Finally, FIG. 1C illustrates this web-link program's unique user tracking and reporting system. This system is more extensive than any other similar program. It is available to the linkees real-time over the Internet using their identification number and a unique password, as input in the exemplary screen form shown in FIG. 6.

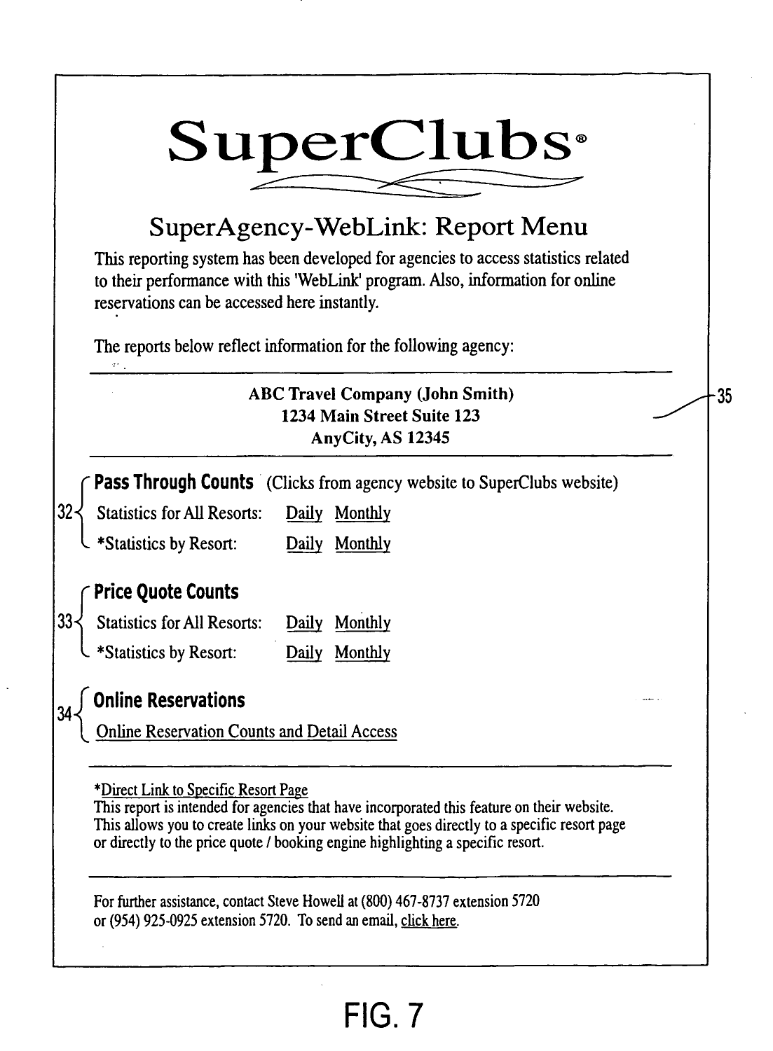

A travel agent goes to Superclubs' Travel Agent Home Page, block 19, and logs in at block 20. The travel agent is then connected to the reporting system at block 21. As shown by the Report Menu of FIG. 7, this system reports the number of click-throughs in field 32, the number of price quotes in field 33, and the number of reservations (made both by linkee's employees and linkees web site visitors) in field 34.

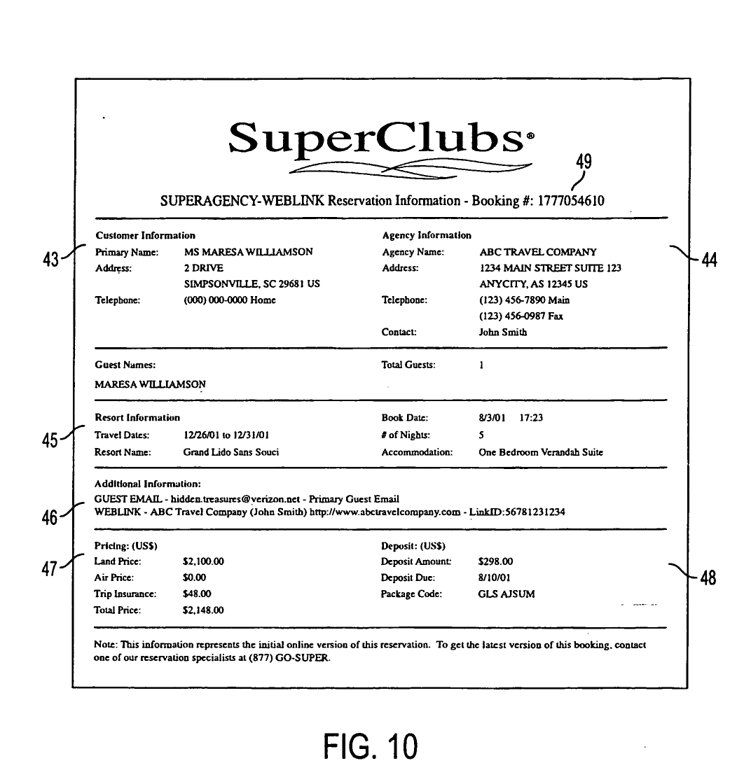

The reports also show the original details of every on-line reservation made, as shown in FIG. 10. For example, the customer information is recorded in field 43. The agency information is recorded in field 44. The resort information is recorded in field 45. Additional information is recorded in field 46. The trip prices are reported in field 47. The deposit amount is identified in field 48. Last, the booking number is identified in field 49.

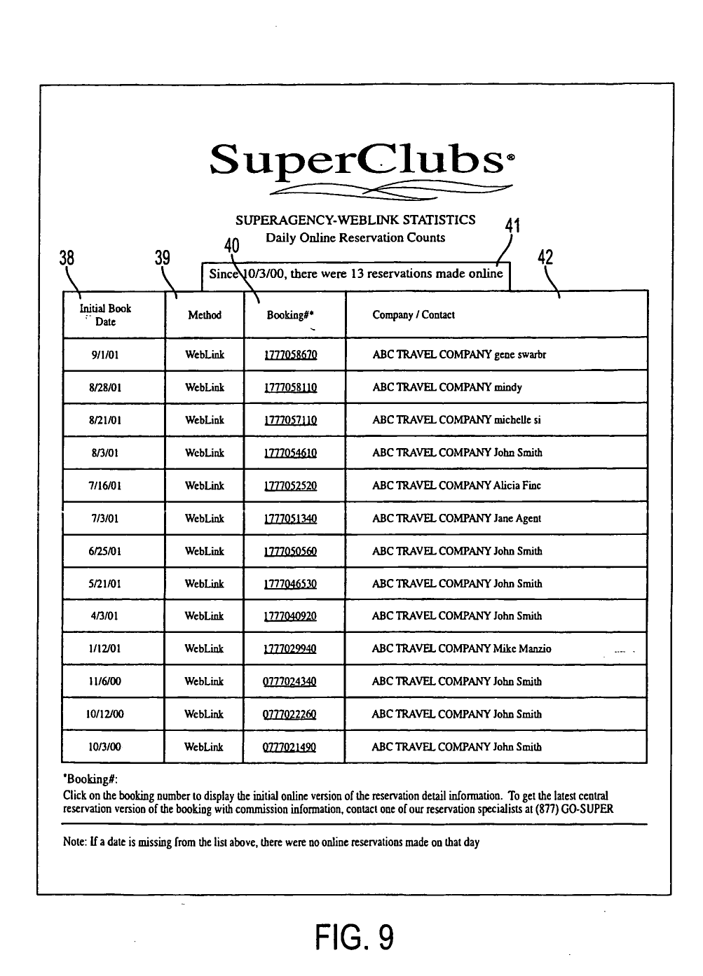

Next, the reports are sorted by hotels (in this instance), home pages linked to, and price quotes given, as well as click-throughs to corporate and brand home pages, see FIG. 9. The date of booking is identified in field 38. The method used to make the reservation is identified in field 39. The booking number is identified in field 40. The company name and contact person is identified in field 42. Last, the total number of reservations made on-line is reported in field 41.

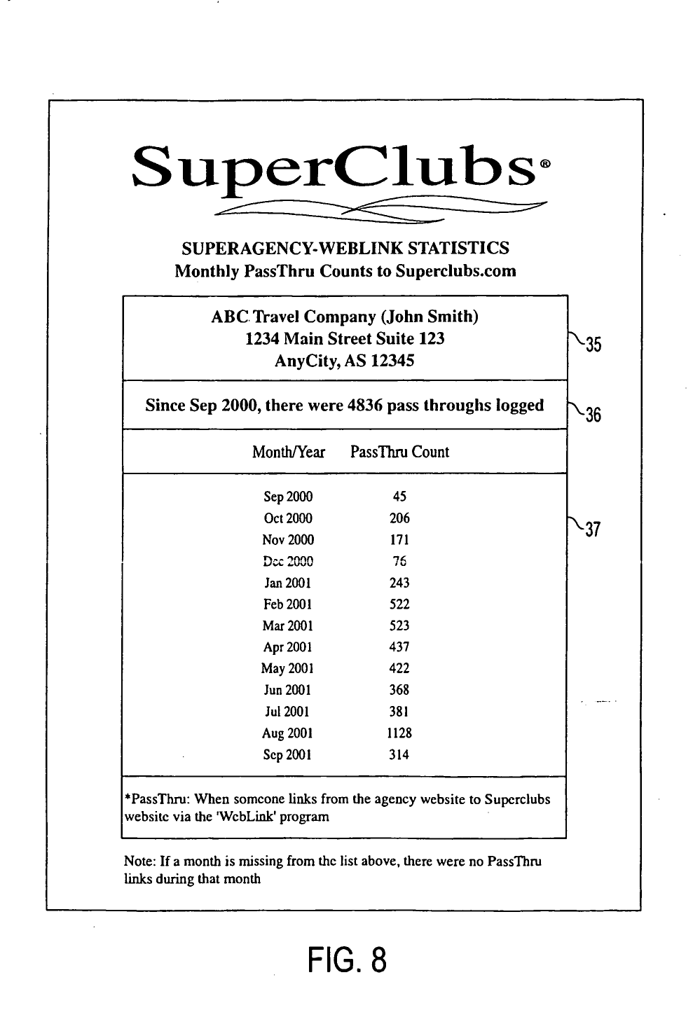

These reports can all be shown by day or by month and always include a total number, see FIG. 8. The travel agency or affiliate identification is listed in field 35. Totals are reported in field 36. Last, monthly totals are reported in field 37. All of these daily/monthly statistics can be accessed by a travel agent at any time, block 22.

The invention thus provides a unique online reservation and booking system which is cross-branded by the linking of multiple website URLs, and which provides detailed auditing and reporting capabilities which validate the dissemination and use of the system.

1. A method for providing web site visitors with vendor and affiliate information, comprising the steps of:
a) providing on a page of an affiliate web site information relating to a vendor, and a link corresponding to a page on the vendor's web site; and
b) providing on the page of the vendor's web site corresponding to the link of step a) information relating to the affiliate and information relating to the vendor's products or services.

2. The method of claim 1 further comprising providing a link to the affiliate web site.

3. The method of claim 1 further comprising the step of providing the affiliate with a unique link for placement on an affiliate web site and corresponding to a page on a vendor's web site.

4. The method of claim 3 wherein the unique link comprises a unique code for identifying the affiliate.

5. The method of claim 3 wherein the link generates a cookie on a web site visitor's computer when activated.

6. The method of claim 5 further comprising the step of determining from the cookie on the web site visitor's computer what affiliate information to display.

7. The method of claim 6 further comprising the step of displaying the appropriate affiliate information on the vendor's web site.

8. A statistical tracking and reporting system for collecting data from integrated web sites, comprising:
a tracking means for recording statistics, such as the number of click-through's, price quotes, and on-line reservations; and
a reporting means for displaying summaries of the recorded statistics by day or month, the reporting means sorts the reports by hotels, home pages linked to, price quotes given, and click-through's to home pages.

9. A method for establishing vendor-affiliate relationships, comprising the steps of:
a) providing the vendor with the appropriate affiliate information to be displayed by filling out an affiliate enrollment form;
b) cross-checking the affiliate enrollment information for approval;
c) providing the affiliate with a unique link for placement on an affiliate web site and corresponding to a page on a vendor's web site; and
d) displaying the appropriate affiliate information.

10. The method of claim 9 wherein the link generates a cookie on a web site visitor's computer when activated.

11. The method of claim 10 wherein the cookie contains information about the affiliate.

12. The method of claim 11 wherein the cookie determines what affiliate information to display.

13. A system for linking and integrating separately controlled computer systems for use in distributing travel information and making travel reservations, the system comprising:
a first computer system supporting a first web site;
a second computer system supporting a second web site;
the two computer systems and web sites being integrated so that attributes of the first web site are combined with attributes of the second web site for presentation to a user; and
a system for collecting data on interaction and use of the two web sites.
